(19) United States
(12) Patent Application Publication
(10) Pub. No.: US 2015/0363774 A1
(43) Pub. Date: Dec. 17, 2015

(54) METHODS AND SYSTEMS FOR PERMISSIONS MANAGEMENT WITH ENHANCED SECURITY

(71) Applicant: SCVNGR, Inc., Boston, MA (US)

(72) Inventors: Seth Priebatsch, Boston, MA (US); Stephen Pomeroy, Somerville, MA (US); Yoni Samlan, Cambridge, MA (US); Constantine S. Walcott, Lexington, MA (US); Kyle Rose, Somerville, MA (US)

(21) Appl. No.: 14/307,066

(22) Filed: Jun. 17, 2014

(51) Int. Cl. G06Q 20/38

(52) U.S. Cl. CPC G06Q 20/3829; G06Q 20/3821; G06Q 2220/00

(57) ABSTRACT

Intercommunicating applications (“apps”) on a computational device (typically, but not necessarily, a mobile device) facilitate completion of an eletronic transaction via interaction with a device user and a remote permissions-management server.

### TECHNICAL FIELD

In various embodiments, the present invention relates generally to systems and methods for facilitating transactional processing of permission requests, e.g., requests to transfer money in order to complete purchase transactions.

### BACKGROUND

Various types of electronic transactions involve one party making a request for access to a resource from another party, which request may be granted based on an explicit permission or transactional conformance to stored permission-granting criteria. One type of permission-related transaction also involves a payment associated with the request (e.g., a purchase for a good or service). Customers may purchase goods or services directly from a merchant or vendor in a variety of ways, including the use of modalities such as credit cards, debit cards, or mobile-phone payment applications; these modalities may be used in person or to complete a transaction remotely. By authorizing payment upon presentation of the transaction details, the customer gives explicit permission to a payment entity to pay the merchant in accordance with the presented terms.

Increasingly, transactions are initiated and consummated using a mobile device. Frequently, vendors or, more generally, entities involved in providing goods and services, entities that manage permissions (e.g., to transfer money upon the request of an account holder to pay for a purchase) and entities that provide access to sensitive or privileged information provide user applications (“apps”) executable on a mobile device to ease or enhance the consumer experience. An online vendor, for example, may provide an app that simplifies a prospective purchaser's ability to shop and pay for a purchase. The vendor may allow customers to designate a desired form of payment, often involving the services of a third-party payment entity such as a credit-card company or other payment service. In such cases, consummation of the transaction electronically depends on highly secure, trusted communication among the consumer, the vendor and the payment entity—or, more specifically, the consumer's mobile device and servers maintained by the other two parties. Preserving security without compromising the consumer convenience that shopping apps provide represents a significant challenge. Unless the consumer's payment information has been stored in advance on the vendor's server, traditional authentication and permissions protocols can require multiple interactions between the consumer and a payment service, degrading the overall customer experience and discouraging use of the payment service to complete transactions. Moreover, payment services increasingly employ restricted payment “tokens” that are limited in some way—e.g., they can only be used on certain types of goods, or within a defined time period. By “token” is meant secure, verifiable data representing confirmation of the recipient's ability to obtain something, typically payment, from the token's issuer. A payment token may be presented as, for example, a barcode, a radiofrequency identification (RFID) code, a “Quick Response” (QR) code by the consumer's mobile device. Consummating transactions involving restricted tokens can, once again, require a sequence of interactions that are cumbersome for the consumer and may work to discourage the use of such tokens despite their security benefits.

### SUMMARY

In general, the present invention relates to security for transactions between intercommunicating applications (“apps”) on a computational device (typically, but not necessarily, a mobile device) and a remote permissions-management server. As used herein, the term “application” refers to a running process—i.e., an instance of a computer program being executed by one or more processors of the computational device. Each running process is separately executed, often by the same processor on a time-sharing basis, and communication between applications occurs via a formal data-exchange process managed by the operating system (i.e., the applications do not share code or address space). Typically, one of the apps is a vendor or “third-party” app, such as a merchant mobile commerce app, while the other is an app provided by the entity that manages permissions. The third-party app generally requests some information or “permissions” from or regarding the user and his account, which is maintained by the backend server of the permissions-management entity (e.g., a payment service). For example, a merchant app might desire the “permission” to charge a user money. Given that the user has the permissions app on his phone, the merchant app may communicate with the permissions app to request permission to charge that account, and, upon receiving such permission, complete the transaction. In typical implementations, at least some of the intercommunication between the apps occurs by “deep linking” and using a security protocol.

This architecture enables secure, convenient coordination between intercommunicating apps on a single device and, by extension, between permission-seeking and permission-granting entities with minimal user inconvenience—and without the need for the user to store sensitive account information on a vendor's server, where it may be vulnerable to theft, and also without additional user steps even if the user's account or payment instrument is restricted in some way. Moreover, this approach actually enhances security by enabling request monitoring; for example, if too much time elapses between a request and a response, the transaction can be canceled before a hacker can gain access to transaction or account information over a compromised communication channel.

Accordingly, in a first aspect, the invention pertains to a method for facilitating an electronic transaction. In various embodiments, the method comprises, at a device including a transceiver and a computer processor, (a) electronically generating, by a first running process executed by the computer processor, a permissions request; (b) electronically receiving, by a second running process executed by the processor in communication with a permissions server, the permissions request generated by the first running process; (c) prompting a user of the device to authorize the requested permissions; (d) causing secure communication, by the second running process via the transceiver, of the received permissions request to the permissions server; (e) receiving, by the second running process from the permissions server via the transceiver, a facilitation token; (f) providing, by the second running process, the received facilitation token to the first running process; and (g) causing transmission, by the first running process via the transceiver, of the facilitation token to complete the electronic transaction.

In some embodiments, step (g) comprises transmission of the facilitation token and an item request to a fulfillment server for (i) re-transmission of the facilitation token to the permissions server and (ii) fulfillment of the item request. The facilitation token may include at least one restriction, in which case the method may further comprise analyzing the restriction(s) of the facilitation token and completing the transaction only if the facilitation token is consistent with the item request.

The permissions request may be, for example, a request for transfer of funds or a request for privileged data. In some embodiments, the method further comprises the steps of generating, by the first running process, first and second paired encryption facilities; supplying, by the first running process, the second encryption facility to the second running process; encrypting, by the second running process following step (e) and using the second encryption facility, the facilitation token received from the permissions server; and decrypting, by the first running process using a first encryption facility, the facilitation token received from the second running process. For example, the first encryption facility may be a private key and the second encryption facility a public key. Alternatively, the first and second encryption facilities may be a random key pairing.

In some embodiments, the first and second running processes communicate via deep linking. The permissions request may take the form of a resource identifier having embedded therein the request, an identifier of the first running process, and a return destination; the second running process processes the resource identifier to obtain the permissions request for communication to the permissions server in step (d) and the return address for providing the received facilitation token to the first running process in step (f).

In some embodiments, the method further comprises monitoring an elapsed time following communication by the first running process of the permissions request to the second running process, and if the first running process has not received the token when the elapsed time reaches a predetermined threshold, causing cancellation of the transaction. Alternatively or in addition, the method may further comprise monitoring an elapsed time following receipt of the token by the second running process, and if the first running process has not received the token when the elapsed time reaches a predetermined threshold, causing cancellation of the transaction.

In another aspect, the invention pertains to a method for facilitating an electronic transaction on a device including a transceiver and a computer processor. The method is performed by a first process executed by the computer processor in communication with a permissions server via the transceiver, and in various embodiments, comprises the steps of (a) receiving, from a second running process executed by the computer processor, a permissions request; (b) prompting a user of the device to authorize the requested permissions; (c) securely communicating the received permissions request to the permissions server; (d) receiving, from the permissions server, via the transceiver, a facilitation token; and (e) providing to the second running process the received facilitation token, wherein the received facilitation token is effective to authorize the permissions server to process an electronic transaction submitted to the permissions server by the second running process.

In a further aspect, the invention relates to a computational device comprising a memory; a transceiver; and a computer processor for executing computer instructions and configured to computationally execute the steps of: (a) causing generation, by a first running process, of a permissions request; (b) causing receipt, by a second running process, of the permissions request generated by the first running process; (c) prompting a user of the device to authorize the requested permissions; (d) causing secure communication, by the second running process via the transceiver, of the received permissions request to a permissions server; (e) causing receipt, by the second running process from the permissions server via the transceiver, of a facilitation token; (f) causing the second running process to provide the received facilitation token to the first running process; and (g) causing transmission, by the first running process via the transceiver, of the facilitation token to complete the transaction.

The permissions request may be, for example, a request for transfer of funds or a request for privileged data, The first running process may be configured to generate first and second paired encryption facilities—e.g., a private key and a public key, or a random key pairing. The first and second running processes may communicate via deep linking.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 schematically illustrates a mobile device in accordance with an embodiment hereof.

FIG. 2 schematically illustrates a permissions server in accordance with an embodiment hereof.

FIG. 3 is a workflow diagram illustrating the operation of an embodiment involving the device and server depicted in FIGS. 1 and 2.

### DETAILED DESCRIPTION

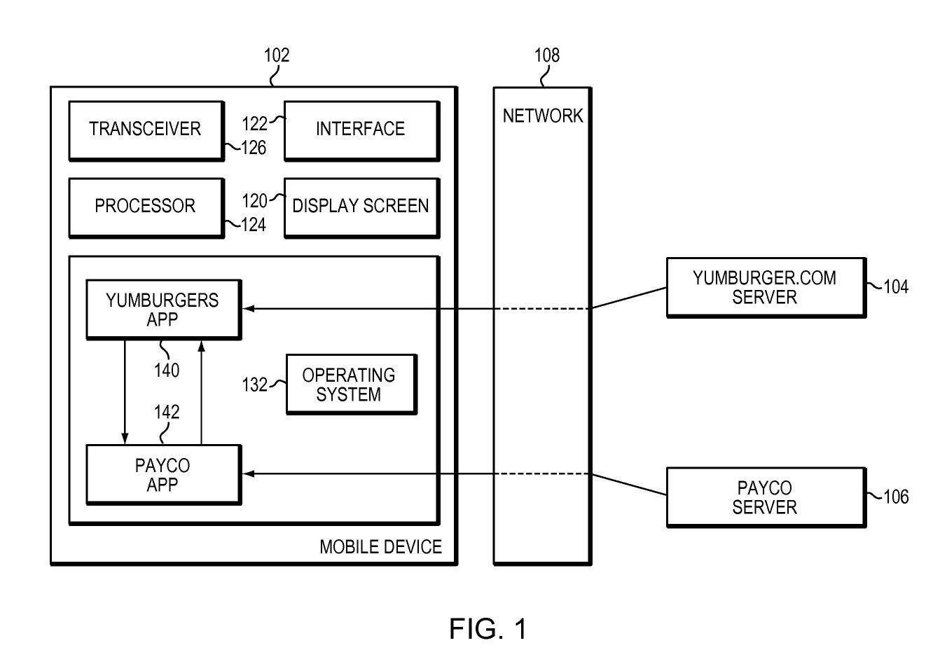

For ease of explanation, the ensuing discussion will focus on a retail food scenario involving a consumer, a food vendor (Yumburgers), and a payment service (Payco); it should be understood, however, that the invention is broadly applicable to management of access to any resource. As shown in FIG. 1, the consumer orders and pays for a hamburger using a mobile device 102. As used herein, the term “mobile device” used for transacting a mobile payment or permissions transaction refers to a “smart phone” or tablet with advanced computing ability that, generally, facilitates bi-directional communication and data transfer using a mobile telecommunication network, and is capable of executing locally stored applications and/or payment transactions. Mobile devices include, for example, IPHONES (available from Apple Inc., Cupertino, Calif.), BLACKBERRY devices (available from Research in Motion, Waterloo, Ontario, Canada), or any smart phones equipped with the ANDROID platform (available from Google Inc., Mountain View, Calif.), tablets, such as the IPAD and KINDLE FIRE, and personal digital assistants (PDAs).

The mobile device, in turn, communicates with the Yumberger server 104 and the Payco server 106 via a network 108 that supports wired, wireless, or any two-way communication (e.g., a cellular telephone network, the Internet, or any wide-area network or combination of networks capable of supporting point-to-point data transfer and communication). The mobile device 102 includes a conventional display screen 120, a user interface 122, a computer processor 124, a transceiver 126, and a memory 130. The transceiver 126 may be a conventional component (e.g., a network interface or transceiver) designed to provide communications with a network, such as the Internet and/or any other land-based or wireless telecommunications network or system, and, through the network, with the servers 104, 106. The memory 130 includes an operating system (OS) 132, such as GOOGLE ANDROID, NOKIA SYMBIAN, BLACKBERRY RIM or MICROSOFT WINDOWS MOBILE, and two concurrently executing applications—a Yumburgers app 140 that permits the consumer to conveniently browse the Yumburgers menu, place orders and select a payment option for completing the transaction, and a Payco app 142 that actually effects payment to Yumburgers. Payco represents one of perhaps several payment options that the consumer may select with the Yumburgers app 140. The user interacts at least with the Yumburgers app 140 via the interface 122 (e.g., by means of a touchscreen), and once the user manifests selection of the Payco option, the payment sequence described in greater detail below is initiated.

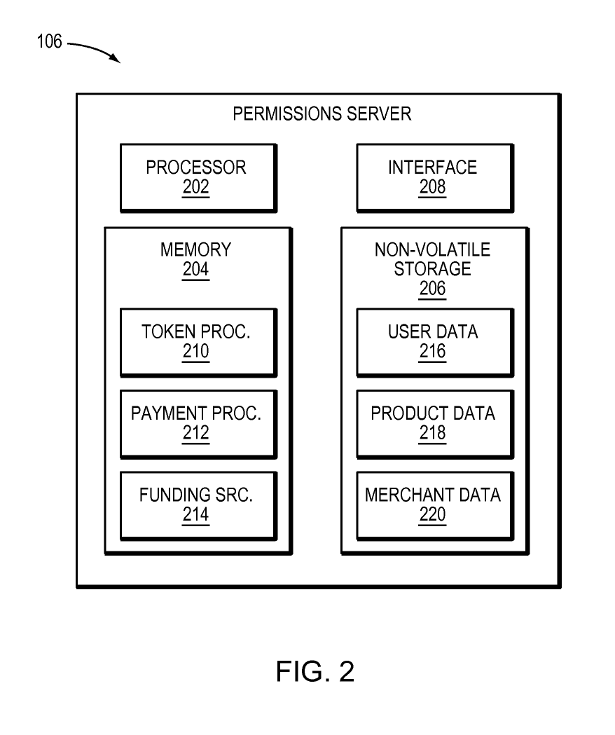

The Yumburgers server 104 is a conventional merchant server with suitable computational, communication, webserver and database capabilities to register orders, arrange for delivery or communicate an order to a store location for food preparation and customer pickup, and accept payment. The Payco server 106 is illustrated in greater detail in FIG. 2, and will be described more generically as a permission-management system. The server 106 shown in FIG. 2 is configured for conditionally granting requests such as, but not limited to, payment-processing requests. As is also true for the merchant (Yumburgers.com) server 104, the system 106 may be any computing device or group thereof, such as a server, group of servers, software-as-a-service providers, or any other such device. The system 106 includes a processor 202, a memory 204, non-volatile storage 206 (e.g., a disk or database), and a network interface 208. The non-volatile storage may be local to the system 106 or may be remote or distributed and accessed via a network connection. Indeed, the functionality of all system resources described herein may be distributed among multiple devices or virtualized according to routine design choice. The memory 204 may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by the processor 202.

In one embodiment, a token-processing module 210 in memory 204 includes computer instructions for generating tokens or receiving them from a dedicated token server. The tokens may be encrypted using public-key cryptography or signed with a digital signature for subsequent verifiability, and are provided to requesting payment apps as described below. The tokens may contain restrictions. For example, a token purchased as a gift certificate may be merchant-specific, limited to use on a specific category of goods, or even restricted to purchase of a particular item; a merchant may issue a limited-time offer as a token that expires at a set time; or a token purchased for a child may specify a maximum amount that may be charged per time period and/or a maximum number of items to be purchased. Such tokens are said to be “scoped,” i.e., they have a limited rather than universal scope of usage.

During token creation, the details of the permission scope may be set by input from a user on whose behalf the token is created and/or by requests, prompts, or questions sent to the user by a request manager and/or resource. These restrictions may be embedded into the token itself and/or may be stored in one or more associated databases keyed to the tokens, e.g., a database 216 specifying users, a database 218 specifying products and product categories, and a database 220 specifying merchants. Further details regarding generation of secure payment tokens are described in, for example, U.S. patent application Ser. Nos. 13/718,466, filed on Dec. 18, 2012, and Ser. No. 13/960,260, filed on Aug. 6, 2013, the entire disclosures of which are hereby incorporated by reference in their entireties.

The token-processing module 210 analyzes previously transmitted tokens that are received back in accordance with the below-described methodology. For example, in PKI cryptography, the token-processing module 210 may attempt to decrypt the token using the private key corresponding to the public key with which the token was encrypted; alternatively, the module 210 may instead verify the associated digital signature to confirm authenticity. The token-processing module 210 may also analyze the received token to determine whether the request for goods or services accompanying the token is consistent with any restrictions in the token. In various embodiments, the token identifies a payment instrument or payment account. If a received request is determined to be consistent in scope with the accompanying token, the payment-processing module 212 approves the request and processes a payment in accordance with the token. The payment-processing module 212 may draw funds needed for payment from a funding source 214, which may in fact operate the server 106 or may be an external funding source, such as a bank, credit card, debit card, or payment aggregator. If the funds are successfully procured, the payment-processing module 212 sends the funds electronically, via the network interface 208, to the requesting resource. One of skill in the art will understand, however, that the procurement of funds is not a prerequisite to sending funds to the resource, and procurement may occur later, or not at all.

The non-volatile storage 206 may collect information about the requester, the resource, and/or granted requests. Information about the requester, such as name, address, email address, phone number, financial account information, location, and buying/shopping history may be stored in the user database 216. Information about the products and/or services purchased may be stored in the product and services database 218. This information may include, for example, numbers of purchases of a given product or service; numbers of purchases of types, categories, or classifications of products or services; locations of purchases; times and dates of purchases; purchase trends; correlations between different products or services purchased; or any other type of similar information. In a permissions context, the database 218 may contain restrictions associated with provisioned or licensed content, and a running process within the memory 204 may periodically verify compliance by recipients of the licensed material—e.g., by searching the web for watermarks associated with licensed digital images and ensuring they have not proliferated or been used in an unauthorized manner.

Information about resources may be stored in a merchant database 220. This information may include, for example, products and services purchased from a merchant or set of merchants; rates of purchases; locations of purchases; times and dates of purchases; purchase trends; correlations between different products or services purchased; or any other type of similar information.

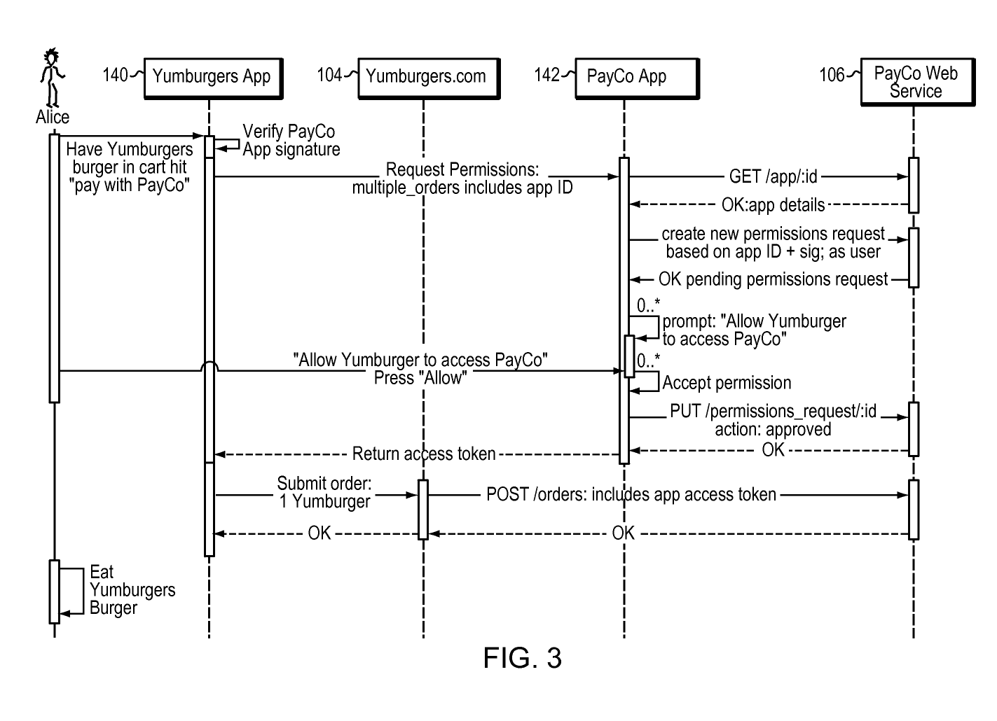

Operation of an embodiment of the invention is illustrated in FIG. 3, which should be read in conjunction with FIGS. 1 and 2. FIG. 3 illustrates the actions that the requester, request manager, permission manager, and resource may carry out, as indicated by their respective columns in the figure, with time advancing downwardly; the present invention, however, is not limited to only the illustrated actions, actors, and depicted steps (i.e., the steps may be combined and/or separated, as one of skill in the art will understand). A consumer, Alice, wishes to pay for a Yumburgers hamburger using her mobile device 102. She launches the Yumburgers app 140 and, via the interface 122, selects a burger and adds it to her “cart”—i.e., her order as maintained by the app 140. The app 140 offers a plurality of payment options and, at time T₁, Alice selects “Payco.” The Yumburgers app 140 thereupon verifies the signature of the Payco app 142 in a conventional fashion, and sends a permissions request to the Payco app 142 along with an ID for the app 140. In this case, the request is for permission to create multiple orders (i.e., charges via Payco) to Alice's account over time. The payment app 142 communicates the permissions request, along with the ID of the app 140 and an identification of the user (Alice), to the Payco payment server 106. This communication occurs through a secure channel, e.g., via a secure communications protocol such as HTTPS, SSL, a VPN or an encrypted protocol. The Payco server 106 responds to the Payco app 142 with an acknowledgment. At time T₂ the Payco app 142 transmits a permissions request to the Payco server 106 and, upon receiving an acknowledgment at time T₃, prompts Alice at time T₄, via the interface 122, to grant permission to the Yumburgers app 140 to access Payco via the Payco app 142 and specifically to create multiple orders (i.e., charges) to Alice's account over time. When Alice indicates her confirmation via the display screen 120 at time T₅, the Payco app 142 accepts and communicates the granted permission to the Payco server 106 at time T₆.

The Payco server 106 (i.e., the token process 210 thereof, via the network interface 208) responds by sending a token (which may be a scoped token) to the Payco app 142, which communicates it to the Yumburgers app 140. At this point, the Yumburgers app 140 combines the token with Alice's order and, at time T₇, communicates these to the Yumburgers.com server 104 to complete the order. The server 104, in turn, sends the order (including at least the transaction amount) and payment token to the Payco server 106 in order to obtain payment. This communication typifies the online communication between a merchant server and a payment entity in order to consummate a transaction, but here, the token process 210 of the Payco server 106 assesses the order against any restrictions contained in the received token (which, of course, was the token previously sent by the Payco server 106 to the Payco app 142); if the purchase is consistent with the token scope, the Payco server approves the transaction and sends an approval acknowledgment to the Yumburgers server 104. (The server 104 can also assess the token scope against the order when it is received, either for logging purposes or to avoid attempting to complete a transaction that will be declined by the server 106.) The approval may be sent simultaneously with payment (e.g., crediting Yumburgers' account with Payco or transferring money to a financial account of Yumburgers), and in any case is sufficiently trusted by the Yumburgers.com server 104 that the burger is delivered to Alice, who may now dine.

Communication between apps 140, 142 typically occurs directly, within the device 102, via the operating system 132. In one embodiment, communication occurs by deep linking using a uniform resource identifier (URI) that links to a specific location within the receiving app. In this scenario the initial communication from the Yumburgers app 140 to the Payco app 142 includes a return URI, which is used as a return path by the Payco app 142 when it returns the access token to the Yumburgers app 140 after time T₆. For example, the permissions request may take the form of a URI in which is embedded the request, the ID of the app 140, and a return destination.

The app-to-app communication can involve security measures such as encryption, particularly when the token is communicated. In one embodiment, prior to the initial communication from the Yumburgers app 140 to the Payco app 142 at time T₁, the Yumburgers app 140 generates a key pairing and transmits one of the keys to the Payco app 142 along with the permissions request.

Following time T₆, when the Payco app 142 receives the token from the Payco server 106, the Payco app 142 encrypts the token using the received key, and the Yumburgers app 140 uses the other paired key to decrypt it. The app-to-app communication is not vulnerable to interception (“sniffing”) by malware because it occurs internally, and if malware does intercept the token communicated to the device 102 via the network 108, it will be unable to spoof the process via the Yumburgers app 140, since this app expects an encrypted token; if the app 140 is unable to decrypt the token using the retained key, it communicates with the Payco app 142 to cancel the transaction. In some embodiments, the key pairing generates a public key and a private key (with the public key transmitted to the Payco app 142). In other embodiments, the key pairing is randomly generated by the Yumburgers app 140 and is unique thereto.

The above-described sequence of steps not only ensures security from step to step, but facilitates further security in that the elapsed time between events can be monitored to detect tampering. For example, the Payco server 106 may monitor the elapsed time beginning at T₁ when it receives the initial request or the elapsed time beginning at T₆ when it transmits the token to the Payco app 142. In either case, if more than a threshold time passes and the Payco server still has not received the token back from the Yumburgers server 104, it may cancel the transaction. Similarly, the Payco app 142 may monitor the elapsed time from its receipt of the initial request at T₁ or from its transmission of the token at T₆, and if an acknowledgment is not received from the Payco server 106 indicating completion of the transaction, the Payco app 142 may alert the server 106. Finally, the Yumburgers app 140 may monitor the elapsed time beginning at T₁ when it makes the initial request, and if more than a threshold time passes and the Yumburgers app 140 still has not received a token, it may query the Payco app 142 to determine whether the initial permissions request was ever received. If not, then the request must have been diverted and the transaction is canceled. In other embodiments, exceeding a threshold time may be treated as a signal that an app running on a user's device, or the device itself, has been compromised, e.g., by an entity intercepting requests; this signal can be used to trigger actions beyond transaction cancellation, e.g., blocking the device, blocking the app, and/or communicating with one or both parties to the transaction.

It should be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The various modules and apps described herein can include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, programmable logic devices (PLDs)) used to provide machine instructions and/or data to a programmable processor, including a machine-readable medium that receives machine instructions as a machine-readable signal.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method for facilitating an electronic transaction, the method comprising, at a device including a transceiver and a computer processor:
(a) electronically generating, by a first running process executed by the computer processor, a permissions request;
(b) electronically receiving, by a second running process executed by the processor in communication with a permissions server, the permissions request generated by the first running process;
(c) prompting a user of the device to authorize the requested permissions;
(d) causing secure communication, by the second running process via the transceiver, of the received permissions request to the permissions server;
(e) receiving, by the second running process from the permissions server via the transceiver, a facilitation token;
(f) providing, by the second running process, the received facilitation token to the first running process; and
(g) causing transmission, by the first running process via the transceiver, of the facilitation token to complete the electronic transaction.

2. The method of claim 1, wherein step (g) comprises transmission of the facilitation token and an item request to a fulfillment server for (i) re-transmission of the facilitation token to the permissions server and (ii) fulfillment of the item request.

3. The method of claim 1, wherein the facilitation token includes at least one restriction.

4. The method of claim 3, further comprising analyzing the at least one restriction of the facilitation token and completing the transaction only if the facilitation token is consistent with the item request.

5. The method of claim 1, wherein the permissions request is a request for transfer of funds.

6. The method of claim 1, wherein the permissions request is a request for privileged data.

7. The method of claim 1, further comprising the steps of:
generating, by the first running process, first and second paired encryption facilities;
supplying, by the first running process, the second encryption facility to the second running process;
encrypting, by the second running process following step (e) and using the second encryption facility, the facilitation token received from the permissions server; and
decrypting, by the first running process using a first encryption facility, the facilitation token received from the second running process.

8. The method of claim 7, wherein the first encryption facility is a private key and the second encryption facility is a public key.

9. The method of claim 7, wherein the first and second encryption facilities are a random key pairing.

10. The method of claim 1, wherein the first and second running processes communicate via deep linking.

11. The method of claim 10, wherein the permissions request is in the form of a resource identifier having embedded therein the request, an identifier of the first running process, and a return destination, the second running process processing the resource identifier to obtain the permissions request for communication to the permissions server in step (d) and the return address for providing the received facilitation token to the first running process in step (f).

12. The method of claim 1, further comprising monitoring an elapsed time following communication by the first running process of the permissions request to the second running process, and if the first running process has not received the token when the elapsed time reaches a predetermined threshold, causing cancellation of the transaction.

13. The method of claim 1, further comprising monitoring an elapsed time following receipt of the token by the second running process, and if the first running process has not received the token when the elapsed time reaches a predetermined threshold, causing cancellation of the transaction.

14. A method for facilitating an electronic transaction on a device including a transceiver and a computer processor, by a first process executed by the computer processor in communication with a permissions server via the transceiver, the method comprising the steps of:
(a) receiving, from a second running process executed by the computer processor, a permissions request;
(b) prompting a user of the device to authorize the requested permissions;
(c) securely communicating the received permissions request to the permissions server;
(d) receiving, from the permissions server via the transceiver, a facilitation token; and
(e) providing to the second running process the received facilitation token, wherein the received facilitation token is effective to authorize the permissions server to process an electronic transaction submitted to the permissions server by the second running process.

15. A computational device comprising:
a memory;
a transceiver; and
a computer processor for executing computer instructions and configured computationally execute the steps of:
(a) causing generation, by a first running process, of a permissions request;
(b) causing receipt, by a second running process, of the permissions request generated by the first running process;
(c) prompting a user of the device to authorize the requested permissions;
(d) causing secure communication, by the second running process via the transceiver, of the received permissions request to a permissions server;
(e) causing receipt, by the second running process from the permissions server via the transceiver, of a facilitation token;
(f) causing the second running process to provide the received facilitation token to the first running process; and
(g) causing transmission, by the first running process via the transceiver, of the facilitation token to complete the transaction.

16. The device of claim 15, wherein the permissions request is a request for transfer of funds.

17. The device of claim 15, wherein the permissions request is a request for privileged data.

18. The device of claim 15, wherein the first running process is configured to generate first and second paired encryption facilities.

19. The device of claim 18, wherein the first encryption facility is a private key and the second encryption facility is a public key.

20. The device of claim 18, wherein the first and second encryption facilities are a random key pairing.

21. The device of claim 15, wherein the first and second running processes communicate via deep linking.
